(19) United States
(12) Patent Application Publication
(10) Pub. No.: US 2023/0139013 A1
(43) Pub. Date: May 4, 2023

(54) VEHICLE OCCUPANT PHYSICAL STATE DETECTION

(71) Applicant: Ford Global Technologies, LLC, Dearborn, MI (US)

(72) Inventors: Kaushik Balakrishnan, Fremont, CA (US); Praveen Narayanan, San Jose, CA (US); Justin Miller, Berkley, MI (US); Devesh Upadhyay, Canton, MI (US)

(73) Assignee: Ford Global technologies, LLC, Dearborn, MI (US)

(21) Appl. No.: 17/518,623

(22) Filed: Nov. 4, 2021

(51) Int. Cl. G06K 9/00; G06K 9/32; G06K 9/62; G06T 7/11; B60W 40/08; B60W 50/00; G06N 3/08

(52) U.S. Cl. CPC G06K 9/00838; G06K 9/00362; G06K 9/3233; G06K 9/6259; G06T 7/11; B60W 40/08; B60W 50/0098; G06N 3/08; G06T 2207/20081; G06T 2207/20084; G06T 2207/30196; G06T 2207/30268; B60W 2040/0881; B60W 2050/0083; B60W 2540/223; B60W 2540/225

(57) ABSTRACT

An image including a vehicle seat and a seatbelt webbing for the vehicle seat is obtained. The image is input to a neural network trained to, upon determining a presence of an occupant in the vehicle seat, output a physical state of the occupant and a seatbelt webbing state. Respective classifications for the physical state and the seatbelt webbing state are determined. The classifications are one of preferred or nonpreferred. A vehicle component is actuated based on the classification for at least one of the physical state of the occupant or the seatbelt webbing state being nonpreferred.

### BACKGROUND

Deep neural networks can be trained to perform a variety of computing tasks. For example, neural networks can be trained to extract data from images. Data extracted from images by deep neural networks can be used by computing devices to operate systems including vehicles. Images can be acquired by sensors included in a system and processed using deep neural networks to determine data regarding objects in an environment around a system. Operation of a system can be supported by acquiring accurate and timely data regarding objects in a system's environment.

### BRIEF DESCRIPTION OF THE DRAWINGS

FIG. 1 is a diagram of an example control system for a vehicle.

FIG. 2 is a top view of an example vehicle with a passenger cabin exposed for illustration.

FIG. 3 is a perspective view of a seat of the vehicle.

FIG. 4 is a diagram of an occupant detection system.

FIG. 5 is a diagram of an example deep neural network.

FIG. 6 is a diagram of exemplary fully-connected layers including a plurality of nodes in an output layer.

FIG. 7 is a diagram of a Bootstrap Your Own Latent configuration.

FIG. 8 is a diagram of a Barlow Twins configuration.

FIG. 9 is an example image including a vehicle seat and a seatbelt webbing for the vehicle seat.

FIG. 10 is a flowchart of an example process for actuating vehicle components based on a plurality of features for an occupant.

### DETAILED DESCRIPTION

A vehicle can include a plurality of sensors positioned to acquire data about an environment internal to a passenger cabin of the vehicle. For example, the vehicle computer can receive data from one or more sensors concerning the environment internal to the passenger cabin of the vehicle and can use this data to monitor behavior of an occupant within the passenger cabin. The vehicle computer can input the sensor data into respective machine learning programs that output one of a plurality of features for the occupant. A feature of an occupant herein means a set of one or more data that describe a physical condition specific to the occupant. For example, occupant features can include a determination of a presence or an absence of the occupant in the vehicle seat, an identification of a physical state for the occupant, e.g., occupant looking at or away from a road, occupant is turned in a seat, etc., an identification of a seatbelt webbing state, an identification of an occupant pose, and an identification of a bounding box for the occupant. The vehicle computer can then actuate vehicle components based on one or more of the features. However, maintaining independent machine learning programs to identify respective features requires significant computational resources and requires annotation, i.e., providing labels that indicate features within the data, which can be cumbersome.

Advantageously, a neural network can be trained to accept an image including a vehicle seat and a seatbelt webbing for the vehicle seat and to generate an output of a plurality of features of an occupant, e.g., a physical state for the occupant and a seatbelt webbing state. A vehicle computer can then actuate a vehicle component based on at least one of the features e.g., the physical state or the seatbelt webbing state, being classified as nonpreferred. In some implementations, the neural network can be further trained to verify the physical state of the occupant by determining a pose of the occupant and, upon determining a bounding box for the occupant, to verify the seatbelt webbing state by comparing the seatbelt webbing state to the bounding box. Techniques disclosed herein improve occupant behavior detection by using the neural network to determine a plurality of features for the occupant, which can reduce computational resources required to determine the plurality of features for the occupant and actuate vehicle component(s) based on the determined features.

A system includes a computer including a processor and a memory, the memory storing instructions executable by the processor to obtain an image including a vehicle seat and a seatbelt webbing for the vehicle seat. The instructions further include instructions to input the image to a neural network trained to, upon determining a presence of an occupant in the vehicle seat, output a physical state of the occupant and a seatbelt webbing state. The instructions further include instructions to determine respective classifications for the physical state and the seatbelt webbing state. The classifications are one of preferred or nonpreferred. The instructions further include instructions to actuate a vehicle component based on the classification for at least one of the physical state of the occupant or the seatbelt webbing state being nonpreferred.

The neural network can be further trained to, upon determining the presence of the occupant in the vehicle seat, output a bounding box for the occupant based on the image. The instructions can further include instructions to classify the seatbelt webbing state based on comparing the seatbelt webbing state to the bounding box. The instructions can further include instructions to verify the classification for the seatbelt webbing state based on comparing an updated seatbelt webbing state to an updated bounding box.

The neural network can be further trained to, upon determining the presence of the occupant in the vehicle seat, output a pose of the occupant based on determining keypoints in the image that correspond to body parts of the occupant. The instructions can further include instructions to verify the physical state of the occupant based on the pose.

The vehicle component can be at least one of a lighting component or an audio component. The instructions can further include instructions to prevent actuation of the vehicle component based on determining an absence of the occupant in the vehicle seat. The instructions can further include instructions to prevent actuation of the vehicle component based on the classifications for the seatbelt webbing state and the physical state being preferred.

The neural network can include a convolutional neural network having convolutional layers that output latent variables to fully connected layers.

The convolutional neural network can be trained in a self-supervised mode using two augmented images generated from one training image and a Bootstrap Your Own Latent configuration. The one training image can be selected from a plurality of training images. Each of the plurality of training images can lack annotations.

The convolutional neural network can be trained in a self-supervised mode using two augmented images generated from one training image and a Barlow Twins configuration. The one training image can be selected from a plurality of training images. Each of the plurality of training images can lack annotations.

The convolutional neural network can be trained in a semi-supervised mode using two augmented images generated from one training image and a Bootstrap Your Own Latent configuration. The one training image can be selected from a plurality of training images. Only a subset of the training images including annotations.

The convolutional neural network can be trained in a semi-supervised mode using two augmented images generated from one training image and a Barlow Twins configuration. The one training image can be selected from a plurality of training images. Only a subset of the training images including annotations.

The neural network may be trained to determine the seatbelt webbing state based on semantic segmentation.

The neural network can output a plurality of features for the occupant, including at least the determination of the presence of the occupant in the vehicle seat, the physical state of the occupant, and the seatbelt webbing state. The neural network can be trained in a multi-task mode by determining a total offset based on offsets for the respective features and updating parameters of a loss function based on the total offset.

The system can include a remote computer including a second processor and a second memory storing instructions executable by the second processor to update the neural network based on aggregated data including data, received from a plurality of vehicles, indicating respective physical states and respective seatbelt webbing states. The instructions can further include instructions to provide the updated neural network to the computer. The aggregated data can further include data, received from a plurality of vehicles, indicating bounding boxes for respective occupants and poses for respective occupants.

A method includes obtaining an image including a vehicle seat and a seatbelt webbing for the vehicle seat. The method further includes inputting the image to a neural network trained to, upon determining a presence of an occupant in the vehicle seat, output a physical state of the occupant and a seatbelt webbing state. The method further includes determining respective classifications for the physical state and the seatbelt webbing state. The classifications are one of preferred or nonpreferred. The method further includes actuating a vehicle component based on the classification for at least one of the physical state of the occupant or the seatbelt webbing state being nonpreferred.

The vehicle component can be at least one of a lighting component or an audio component. The method can further include preventing actuation of the vehicle component based on determining an absence of the occupant in the vehicle seat. The method can further include preventing actuation of the vehicle component based on the classifications for the seatbelt webbing state and the physical state being preferred.

Further disclosed herein is a computing device programmed to execute any of the above method steps. Yet further disclosed herein is a computer program product, including a computer readable medium storing instructions executable by a computer processor, to execute an of the above method steps.

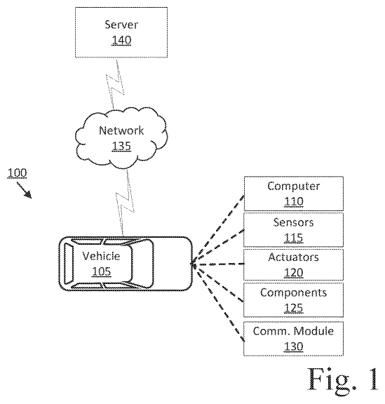

With reference to FIGS. 1-9, an example control system 100 includes a vehicle 105. A vehicle computer 110 in the vehicle 105 receives data from sensors 115. The vehicle computer 110 is programmed to obtain an image 402 including a vehicle seat 202 and a seatbelt webbing 304 for the vehicle seat 202. The instructions further include instructions to input the image to a neural network 500 trained to, upon determining a presence of an occupant in the vehicle seat 202, output a physical state 406 of the occupant and a seatbelt webbing state 412. The instructions further include instructions to determine respective classifications for the physical state 406 and the seatbelt webbing state 412. The classifications are one of preferred or nonpreferred. The instructions further include instructions to actuate a vehicle component 125 based on the classification for at least one of the physical state 406 of the occupant or the seatbelt webbing state 412 being nonpreferred.

Turning now to FIG. 1, the vehicle 105 includes the vehicle computer 110, sensors 115, actuators 120 to actuate various vehicle components 125, and a vehicle 105 communication module 130. The communication module 130 allows the vehicle computer 110 to communicate with a remote server computer 140, and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above and/or may include a dedicated electronic circuit including an ASIC that is manufactured for a particular operation, e.g., an ASIC for processing sensor 115 data and/or communicating the sensor 115 data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 110.

The vehicle computer 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicle 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communication network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices, e.g., sensors 115, actuators 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor 115(s), etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115, e.g. front view, side view, etc., providing images from an area surrounding the vehicle 105. As another example, the vehicle 105 can include one or more sensors 115, e.g., camera sensors 115, mounted inside a cabin of the vehicle 105 and oriented to capture images of occupants in the vehicle 105 cabin. In the context of this disclosure, an object is a physical, i.e., material, item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle 105, a sign, a tree, etc., relative to the vehicle 105. As one example, the data may be image data of the environment around the vehicle 105. In such an example, the image data may include one or more objects and/or markings, e.g., lane markings, on or along a road. As another example, the data may be image data of the vehicle 105 cabin, e.g., including occupants and seats in the vehicle 105 cabin. Image data herein means digital image data, i.e., comprising pixels, typically with intensity and color values, that can be acquired by camera sensors 115. The sensors 115 can be mounted to any suitable location in or on the vehicle 105, e.g., on a vehicle 105 bumper, on a vehicle 105 roof, etc., to collect images of the environment around the vehicle 105.

The vehicle 105 actuators 120 are implemented via circuits, chips, or other electronic and or mechanical components that can actuate various vehicle 105 subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the vehicle computer 110 may be configured for communicating via a vehicle-to-vehicle communication module or interface with devices outside of the vehicle 105, e.g., through a vehicle-to-vehicle (V2V) or vehicle-to-infrastructure (V2X) wireless communications (cellular and/or DSRC., etc.) to another vehicle, and/or to a remote server computer 140 (typically via direct radio frequency communications). The communication module could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module include cellular, Bluetooth, IEEE 802.11, dedicated short range communications (DSRC), and/or wide area networks (WAN), including the Internet, providing data communication services.

The network 135 represents one or more mechanisms by which a vehicle computer 110 may communicate with remote computing devices, e.g., the remote server computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks 135 include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or or some other wide area network.

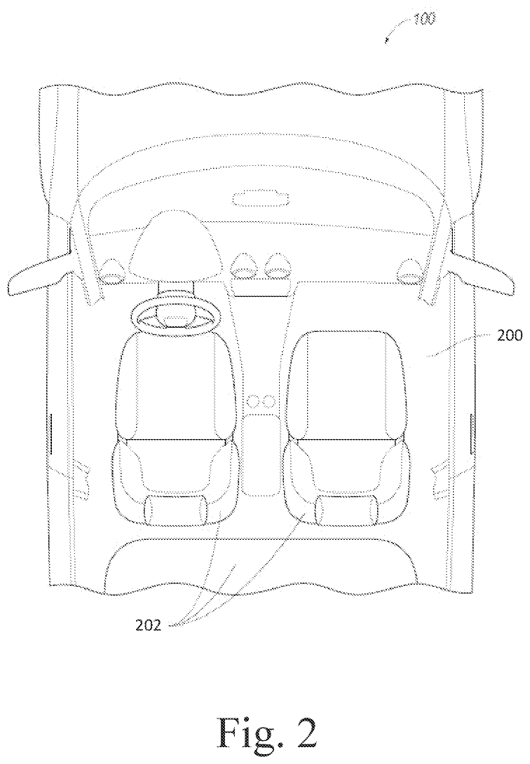

Turning now to FIG. 2, the vehicle 105 includes a passenger cabin 200 to house occupants, if any, of the vehicle 105. The passenger cabin 200 includes one or more front seats 202 disposed at a front of the passenger cabin 200 and one or more back seats 202 disposed behind the front seats 202. The passenger cabin 200 may also include third-row seats (not shown) at a rear of the passenger cabin 200. In FIG. 2, the front seats 202 are shown to be bucket seats and the rear seats 202 are shown to be a bench seat. It will be understood that the seats 202 may be other types.

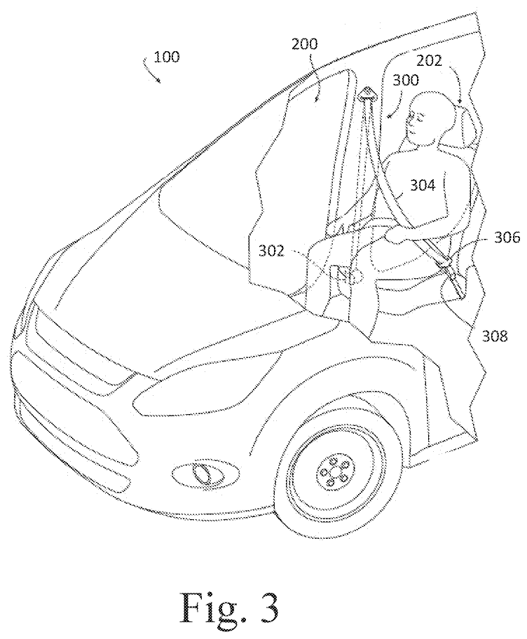

Turning now to FIG. 3, the vehicle 105 includes seatbelt assemblies 300 for the respective seats 202. The seatbelt assembly 300 may include a retractor 302 and a webbing 304 retractably payable from the retractor 302. Additionally, the seatbelt assembly 300 may include an anchor (not shown) coupled to the webbing 304, and a clip 306 selectively engageable with a seatbelt buckle 308. Each seatbelt assembly 300, when fastened, controls the kinematics of the occupant on the respective seat 202, e.g., during sudden decelerations of the vehicle 105.

The retractor 302 may be supported by a body of the vehicle 105. For example, the retractor may be mounted to a pillar, e.g., a B-pillar, of the vehicle body, e.g., via fasteners, welding, etc. In this situation, the retractor 302 is spaced from the seat 202. As another example, the retractor 302 may be supported by the seat 202, e.g., mounted to a seat frame.

The webbing 304 may be retractable to a retracted state and extendable to an extended state relative to the retractor 302. In the retracted state, the webbing 304 may be retracted into the retractor 302, i.e., wound around a spool (not shown). In the extended state, the webbing 304 may be paid out from the retractor 302, e.g., towards the occupant. For example, in the extended state, the clip 306 may be engaged with the seatbelt buckle 308. That is, the webbing 304 may extend across the occupant, e.g., to control kinematics of the occupant in the seat 202. The webbing 304 is moveable between the retracted state and the extended state.

The webbing 304 is retractably engaged with the retractor 210, i.e., feeds into the retractor 210, and is attached to the anchor. The anchor may, for example, be fixed relative to the body of the vehicle 105. For example, the anchor may be attached to the seat 202, the body, etc., e.g., via fasteners. The webbing 304 may be a woven fabric, e.g., woven nylon.

The clip 306 is slideably engaged with the webbing 304. The clip 306 may, for example, slide freely along the webbing 304 and selectively engage with the seatbelt buckle 308. In other words, the webbing 304 may be engageable with the seatbelt buckle 308. The clip 306 may, for example, be releasably engageable with the seatbelt buckle 308 from a buckled position to an unbuckled position. The clip 306 may, for example, be disposed between the anchor and the retractor 302 to pull the webbing 304 during movement from the unbuckled position to the buckled position.

In the unbuckled position, the clip 306 may move relative to the seatbelt buckle 308. In other words, the webbing 304 may be retractable into the retractor 302 when the clip 306 is in the unbuckled position. In the buckled position, the webbing 304 may be fixed relative to the seatbelt buckle 308. In other words, the seatbelt buckle 308 may prevent the webbing 304 from retracting into the retractor 302.

The seatbelt assembly 300 may be a three-point harness meaning that the webbing 304 is attached at three points around the occupant when fastened: the anchor, the retractor 302, and the seatbelt buckle 308. The seatbelt assembly 300 may, alternatively, include another arrangement of attachment points.

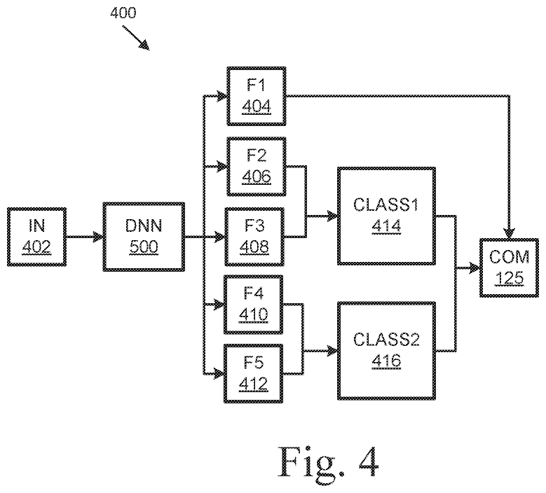

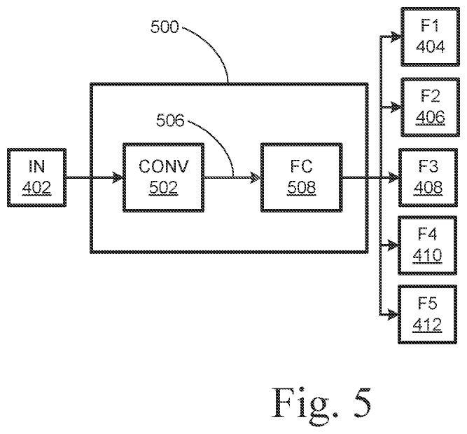

FIG. 4 is a diagram of an example occupant detection system 400, typically implemented as a computer software program, e.g., in a vehicle computer 110, that determines to actuate one or more vehicle components 125 based on a plurality of features 404, 406, 408, 410, 412 for an occupant. The vehicle computer 110 can receive an image 402, e.g., from a camera sensor 115 oriented to capture images of the vehicle 105 cabin. The image 402 can include a vehicle seat 202 and a seatbelt webbing 304 for the vehicle seat 202. The vehicle computer 110 can determine to actuate one or more vehicle components 125 by inputting the image 402 including the vehicle seat 202 and the seatbelt webbing 304 for the vehicle seat 202 into a neural network, such as a deep neural network (DNN) 500 (see FIG. 5). The DNN 500 can be trained (as discussed below) to accept the image 402 as input and to generate an output of a plurality of features 404, 406, 408, 410, 412 for the occupant. The plurality of features 404, 406, 408, 410, 412 include a determination 404 of a presence or an absence of an occupant in the vehicle seat 202, a physical state 406 for the occupant, a pose 408 for the occupant, a bounding box 410 for the occupant, and a seatbelt webbing state 412. The vehicle computer 110 can provide the plurality of features 404, 406, 408, 410, 412 to the remote server computer 140. For example, the vehicle computer 110 can transmit the plurality of features 404, 406, 408, 410, 412 to the remote server computer 140, e.g., via the network 135.

Upon determining an absence of the occupant in the vehicle seat 202, the vehicle computer 110 can prevent actuation of one or more vehicle components 125. For example, the vehicle computer 110 can prevent actuation of a propulsion component 125 based on determining the absence of the occupant from the vehicle seat 202. As another example, the vehicle computer 110 can prevent actuation of an output device in the vehicle 105. For example, the vehicle computer 110 can prevent actuation of a lighting component 125, e.g., a display, interior lights, etc., and/or an audio component 125, e.g., speakers, to not output an audio and/or visual alert when the occupant is not seated in the vehicle seat 202.

Upon determining a presence of the occupant in the vehicle seat 202, the vehicle computer 110 can actuate one or more vehicle components 125 based on respective classifications 414, 416 of the physical state 406 for the occupant and the seatbelt webbing state 412. For example, upon determining at least one of the physical state 406 for the occupant or the seatbelt webbing state 412 is classified as nonpreferred, the vehicle computer 110 can actuate an output device in the vehicle 105. That is, the vehicle computer 110 can actuate a lighting component 125, e.g., a display, interior lights, etc., and/or an audio component 125, e.g., speakers, to output an audio and/or visual alert indicating a nonpreferred physical state 406 and/or seatbelt webbing state 412. As another example, upon determining at least one of the physical state 406 for the occupant or the seatbelt webbing state 412 is classified as nonpreferred, the vehicle computer 110 can actuate a braking component 125 to slow the vehicle 105 and can output, e.g., via a display screen, a prompt for the user to move to a preferred state and/or adjust the seatbelt webbing 304 to a preferred state. As another example, upon determining at least one of the physical state 406 for the occupant or the seatbelt webbing state 412 is classified as nonpreferred, the vehicle computer 110 can actuate a lighting component 125 to illuminate an area within the passenger cabin 200 at which the occupant is looking.

Upon determining the physical state 406 for the occupant and the seatbelt webbing state 412 are classified as preferred, the vehicle computer 110 can prevent actuation of the output device, e.g., in substantially the same manner as discussed above. Additionally, or alternatively, the vehicle computer 110 can actuate the propulsion component 125 to move the vehicle 105 based on determining the physical state 406 for the occupant and the seatbelt webbing state 412 are classified as preferred.

To classify the physical state 406 for the occupant, the vehicle computer 110 can access a look-up table, or the like, e.g., stored in a memory of the vehicle computer 110, that associates various physical states 406 with corresponding classifications 414. An example look-up table is set forth below in Table 1. The physical state 406 for the occupant can be classified as preferred or nonpreferred. Non-limiting examples of physical states 406 for the occupant include alert, e.g., looking at a road, drowsy, distracted, e.g., looking away from the road (e.g., sideways, at a mobile phone, at a display in the vehicle cabin, etc.), eating/drinking, talking on mobile phone, etc.

TABLE 1

| Physical State | Classification |
|---|---|
| Alert | Preferred |
| Drowsy | Nonpreferred |
| Eating/drinking | Nonpreferred |
| Talking on mobile phone | Nonpreferred |
| Distracted | Nonpreferred |

The vehicle computer 110 can verify the physical state 406 for the occupant based on the pose 408 for the occupant. For example, the vehicle computer 110 can determine a posture for the occupant based on the pose 408 for the occupant. A posture refers to a location and orientation of body parts, e.g., arms, shoulders, head, etc., for the occupant relative to each other. The posture can indicate a physical state 406 for the occupant. For example, the posture can indicate that the occupant is drowsy based on the occupant's shoulders and/or head being lowered. As another example, the posture can indicate that the occupant is distracted based on the occupant's arm reaching towards a vehicle component 125, e.g., a display, the occupant's head being tilted, the occupant's shoulders being offset relative to a vehicle lateral axis, etc. As another example, the posture can indicate that the occupant is eating, drinking, and/or talking on a mobile phone based on the occupant's arm extending toward the occupant's head.

Upon determining the posture for the occupant, the vehicle computer 110 can compare the posture for the occupant to the physical state 406 for the occupant output by the DNN 500. If the posture is associated with the physical state 406, then the vehicle computer 110 verifies the physical state 406 for the occupant. If the posture is not associated with to the physical state 406, then the vehicle computer 110 determines to not verify the physical state 406 for the occupant. For example, the look-up table may further include one or more postures associated with respective physical states 406. That is, the vehicle computer 110 can access the look-up table to determine whether the posture is associated with the physical state 406. Upon determining to not verify the physical state 406 for the occupant, the vehicle computer 110 can classify the physical state 406 as nonpreferred.

The seatbelt webbing state 412 is one of the retracted state or the extended state. To classify the seatbelt webbing state 412, the vehicle computer 110 can compare the seatbelt webbing state 412 to the bounding box 410 for the occupant. A “bounding box” is a closed boundary defining a set of pixels. For example, the pixels within a bounding box can represent a same object, e.g., a bounding box can define pixels representing an image of an object. Said differently, a bounding box is typically defined as a smallest rectangular box that includes all of the pixels of the corresponding object. The vehicle computer 110 can detect pixels corresponding to the seatbelt webbing 304, e.g., via semantic segmentation (as discussed below). The vehicle computer 110 then compares the pixels corresponding to the seatbelt webbing 304 to the bounding box 410 for the occupant. That is, the vehicle computer 110 identifies pixels corresponding to the seatbelt webbing 304 contained within the bounding box 410 for the occupant.

The vehicle computer 110 can classify the seatbelt webbing state 212 based on the identified pixels corresponding to the seatbelt webbing 304 contained within the bounding box 410 for the occupant. For example, the vehicle computer 110 can classify the seatbelt webbing state 412 as preferred based on a number of identified pixels being greater than or equal to a threshold. Conversely, the vehicle computer 110 can classify the seatbelt webbing state 412 as nonpreferred based on a number of identified pixels being less than the threshold. As another example, the vehicle computer 110 can classify the seatbelt webbing state 412 as preferred based on the number of identified pixels divided by a total number of pixels corresponding to the seatbelt webbing 304 being greater than or equal to the threshold. Conversely, the vehicle computer 110 can classify the seatbelt webbing state 412 as nonpreferred based on the number of identified pixels divided by the total number of pixels being less than the threshold. The threshold is a numerical value, e.g., an integer, a percentage, etc., above which a vehicle computer classifies a seatbelt webbing state as preferred. The threshold may be stored, e.g., in a memory of the vehicle computer 110. The threshold may, for example, be determined empirically based on testing that allows for determining a minimum number of pixels corresponding to a seatbelt webbing 304 in the extended state for multiple occupants. As another example, the threshold may be determined based on a volume of the occupant's body. In such an example, the vehicle computer 110 can determine the volume of the occupant's body based on image data including the occupant, e.g., using conventional image processing techniques.

As another example, the vehicle computer 110 can classify the seatbelt webbing state 412 as preferred based on a location of the clip 3068 relative to the bounding box 410, e.g., a distance between the clip 306 and an inboard boundary of the bounding box 410 being within a predetermined distance. The predetermined distance is a numerical value, e.g., an integer, a percentage, etc., within which a vehicle computer classifies a seatbelt webbing state as preferred. The predetermined distance may be stored, e.g., in a memory of the vehicle computer 110. The predetermined distance may be determined empirically based on, e.g., testing that allows for determining a minimum distance between a clip 306 and respective boundaries of corresponding bounding boxes for multiple occupants.

The vehicle computer 110 can verify the classification 416 of the seatbelt webbing state 412 based on an updated seatbelt webbing state 412 and an updated bounding box 410. For example, the vehicle computer 110 can receive a second image 402 including the vehicle seat 202 and the seatbelt webbing 304 for the vehicle seat 202. The second image 402 is obtained subsequent to the first image 402. For example, the second image 402 may be obtained upon determining the occupant has moved in the vehicle seat 202, e.g., based on data from a pressure sensor 115 in the vehicle seat 202. Alternatively, the second image 402 may be obtained based on, e.g., a sampling rate for the image sensor 115 acquiring the images, an expiration of a timer, which is initiated upon acquiring the first image 402, etc. The vehicle computer 110 can the input the second image 402 to the DNN 500, and the DNN 500 can output the updated seatbelt webbing state 412 and the updated bounding box 410 for the occupant (in addition to the other features).

The vehicle computer 110 can then classify the updated seatbelt webbing state 412 based on the updated bounding box 410, e.g., in substantially the same manner as discussed above. If the classification 416 for the updated seatbelt webbing state 412 matches the classification 416 for the seatbelt webbing state 412, then the vehicle computer 110 can verify the classification 416 for the seatbelt webbing state 412. If the classification 416 for the updated seatbelt webbing state 412 does not match the classification 416 for the seatbelt webbing state 412, then the vehicle computer 110 can determine to not verify the classification 416 for the seatbelt webbing state 412. In this situation, the vehicle computer 110 can update the classification 416 for the seatbelt webbing state 412 to be nonpreferred. Additionally, the vehicle computer 110 can classify the updated seatbelt webbing state 412 as nonpreferred. Verifying the classification 416 of the seatbelt webbing state 412 allows the vehicle computer 110 to detect situations in which the occupant has positioned the seatbelt webbing 304 in an unpreferred manner.

The remote server computer 140 may be programmed to update the DNN 500 according to federated learning techniques. For example, a plurality of vehicle computers 110 may be programmed to operate respective instances of the DNN 500 received from the remote server computer 140. An instance is a version of a neural network, e.g., including data specifying layers, nodes, weights, etc., of the neural network. Federated learning techniques periodically update instances of the neural network available locally in the vehicle computers to learn and improve their knowledge base using incremental improvement techniques.

The remote server computer 140 can, for example, update the DNN 500 based on aggregated data. Aggregated data means data from a plurality of vehicle computers 110 that provide messages and then combining (e.g., by averaging and/or using some other statistical measure) the results. That is, the remote server computer 140 may be programmed to receive messages from a plurality of vehicle computers 110 indicating respective features (i.e., a determination 404 of a presence or an absence of an occupant in the vehicle seat 202, a bounding box 410 for the occupant, a pose 408 for the occupant, a physical state 406 for the occupant, and a seatbelt webbing state 412) from the respective instances of the DNN 500 based on vehicle 105 data of a plurality of vehicles 105. Based on the aggregated data indicating respective features 404, 406, 408, 410, 412 (e.g., e.g., an average number of messages, a percentage of messages, etc., indicating the respective features 404, 406, 408, 410, 412), and taking advantage of the fact that messages from different vehicles are provided independently of one another, the remote server computer 140 can train the DNN 500, e.g., by updating weights and biases via suitable techniques such as back-propagation with optimizations, based on the vehicle 105 data. The remote server computer 140 can then transmit the updated DNN 500 to a plurality of vehicles, including the vehicle 105, e.g., via the network 135.

FIG. 5 is a diagram of an example deep neural network (DNN) 500 that can be trained to output the plurality of features 404, 406, 408, 410, 412 for the occupant. The DNN 500 can be a software program executing on the remote server computer 140. Once trained, the DNN 500 can be downloaded to the vehicle computer 110. The vehicle computer can use the DNN 500 to operate the vehicle 105. For example, the vehicle computer 110 can use the features 404, 406, 408, 410, 412 from the DNN 500 to determine whether to actuate one or more vehicle components 125, as discussed above.

The DNN 500 can include a plurality of convolutional layers (CONV) 502 that process input images (IN) 402 by convolving the input images 402 using convolution kernels to determine latent variables (LV) 506. The DNN 500 includes a plurality of fully-connected layers (FC) 508 that process the latent variables 506 to produce the plurality of features 404, 406, 408, 410, 412. The DNN 500 can input an image 402 from a camera sensor 115 included in a vehicle 105 that includes the vehicle seat 202 and the seatbelt webbing 304 for the vehicle seat 202 to determine the plurality of features 404, 406, 408, 410, 412.

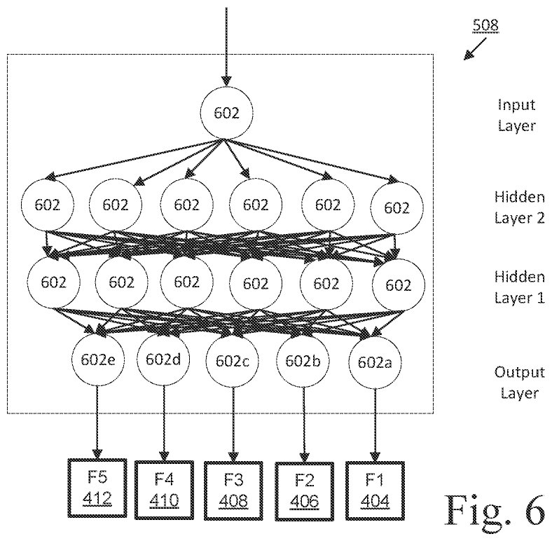

Turning now to FIG. 6, the FC 508 include multiple nodes 602, and the nodes 602 are arranged so that the FC 508 includes an input layer, one or more hidden layers, and an output layer. Each layer of the FC 508 can include a plurality of nodes 602. While FIG. 6 illustrates two hidden layers, it is understood that the FC 508 can include additional or fewer hidden layers. The input layer may also include more than one node 602. The output layer includes five nodes 602 (as discussed above) that correspond to the respective features 404, 406, 408, 410, 412.

The nodes 602 are sometimes referred to as artificial neurons 602, because they are designed to emulate biological, e.g., human, neurons. A set of inputs (represented by the arrows) to each neuron 602 are each multiplied by respective weights. The weighted inputs can then be summed in an input function to provide, possibly adjusted by a bias, a net input. The net input can then be provided to activation function, which in turn provides a connected neuron 602 an output. The activation function can be a variety of suitable functions, typically selected based on empirical analysis. As illustrated by the arrows in FIG. 6, neuron 602 outputs can then be provided for inclusion in a set of inputs to one or more neurons 602 in a next layer.

A first node 602a of the output layer outputs the determination 404 of a presence or an absence of an occupant in the vehicle seat 202. To determine whether an occupant is present in the vehicle seat 202, the first node 602a determines a first logit, i.e., a function that maps probabilities to real numbers, and passes the first logit to a sigmoid function to obtain a probability that an occupant is present in the vehicle seat 202. A “sigmoid function” is, as is well-understood, a mathematical function having a characteristic S-shaped curve or sigmoid curve. The probability is then compared to a predetermined threshold. If the probability is greater than the predetermined threshold, the first node 602a outputs a value of 1, i.e., indicating that an occupant is present in the vehicle seat 202. If the probability is less than or equal to the predetermined threshold, then the first node 602a outputs a value of 0, i.e., indicating that an occupant is absent from the vehicle seat 202. The predetermined threshold may be stored, e.g., in a memory of the vehicle computer 110. The predetermined threshold may be determined empirically, e.g., based on testing that allows for determining a probability that reduces or eliminates false determinations of an occupant being present in a vehicle seat 202.

A second node 602b of the output layer outputs a physical state 406 for the occupant. To determine the physical state 406, the second node 602b determines a one-hot vector. A “one-hot vector” is a 1×N matrix with a single high value (1) and all other values low (0), where N is a number of stored physical states 406 for an occupant. The one-hot vector is then passed to a normalization stage using a softmax layer (and/or some other normalization technique) as a last stage activation function of the FC 508 to obtain probabilities for respective stored physical states 406 for the occupant. The second node 602b then determines the physical state 406 for the occupant by comparing the probabilities and selecting the physical state 406 associated with the greatest probability. The second node 602b then outputs the determined physical state 406 for the occupant. A “softmax function” (also known as softargmax or normalized exponential function) is a generalization of a logistic function to multiple dimensions. A logistic function is a common S-shaped (sigmoid) curve. It is often used as a last activation function of a neural network to normalize the output of a network to a probability distribution over predicted output classes, based on Luce's choice axiom.

A third node 602c of the output layer outputs a pose 408 for the occupant. To determine the pose 518, the third node 602c determines a pair of numerical values, e.g., real numbers, associated with respective body parts for the occupant. Respective pairs of numerical values define x and y coordinates of a corresponding body part for the occupant relative to the pixel coordinate system. The pairs of numerical values are then passed to a normalization stage using a sigmoid function (and/or some other normalization technique) as a last stage activation function of the FC 508 to obtain respective pairs of numerical values normalized, e.g., between 0 and 1, based on dimensions of the image 402. The third node 602c then connects the normalized pairs of numerical values, e.g., according to known data processing techniques, and outputs the pose 408 for the occupant.

A fourth node 602d of the output layer outputs a bounding box 410 for the occupant. To determine the bounding box 410, the fourth node 602d determines four numerical values, e.g., real numbers, defining the bounding box 410 for the occupant. Two of the numerical values define x and y coordinates of a center of the bounding box 410 relative to a pixel coordinate system defined by the image 402. The other two numerical values represent a height and width, respectively, of the bounding box 410 in pixel coordinates. The four numerical values are then passed to a normalization stage using a sigmoid function (and/or some other normalization technique) as a last stage activation function of the FC 508 to obtain numerical values normalized, e.g., between 0 and 1, based on dimensions of the image 402. The fourth node 602d then connects the normalized numerical values representing, e.g., according to known data processing techniques, and outputs the bounding box 410 for the occupant.

A fifth node 602e of the output layer outputs a seatbelt webbing state 412. To determine the seatbelt webbing state 412, the fifth node 602e determines second logits for respective pixels in the image 402 and passes the second logits to the sigmoid function to obtain probabilities that respective pixels include the seatbelt webbing. The respective probabilities are then compared to a second predetermined threshold. If the probability of one pixel is greater than the predetermined threshold, then the fifth node 602e assigns a value of 1 to the one pixel, i.e., the one pixel is determined to include the seatbelt webbing 304. If the probability of the one pixel is less than or equal to the predetermined threshold, then the fifth node 602e assigns a value of 0 to the one pixel, i.e., the one pixel is determined to not include the seatbelt webbing 304. The fifth node 602e then outputs the assigned values for the respective pixels. The second predetermined threshold may be stored, e.g., in a memory of the vehicle computer 110. The second predetermined threshold may be determined empirically, e.g., based on testing that allows for determining a probability that reduces or eliminates false identifications of a seatbelt webbing 304.

The CONV 502 is trained by processing a dataset that includes a plurality of images 402 including various features 404, 406, 408, 410, 412 for various occupants. The CONV 502 can, for example, be trained according to self-supervised learning techniques. In this example, the plurality of images 402 lack annotations of the various features 404, 406, 408, 410, 412. Once the CONV 502 is trained, the DNN 500 is trained by processing the dataset. Training the CONV 502 according to self-supervised learning techniques as compared to unsupervised learning techniques can reduce the amount of time and resources required to label the images 402 in the dataset while improving the accuracy of the DNN 500.

Alternatively, the CONV 502 can be trained according to semi-supervised techniques. In this example, a subset, i.e., some but less than all, of the plurality of images 402 include annotations of the various features 404, 406, 408, 410, 412, and the remaining images 402, i.e., those not included in the subset, lack annotations. Once the CONV 502 is trained, the DNN 500 is trained by processing the dataset. Training the CONV 502 according to semi-supervised learning techniques as compared to unsupervised learning techniques can reduce the amount of time and resources required to label the images 402 in the dataset while improving the accuracy of the DNN 500.

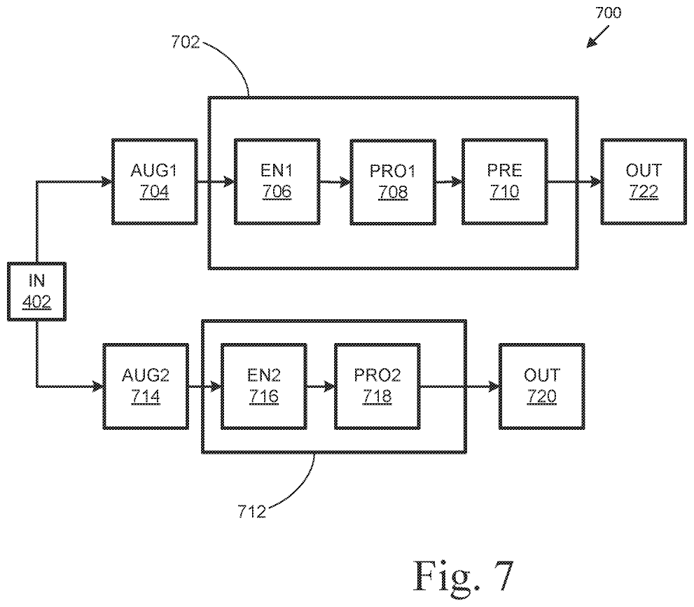

The CONV 502 is trained using one of a Bootstrap Your Own Latent (BYOL) configuration 700 or a Barlow Twins (BT) configuration 800. FIG. 7 is a diagram of an example BYOL configuration 700. A BYOL 700 configuration, as is known, generates, from an input image 402, two augmented images 704, 714 that are different from each other, e.g., by employing image processing techniques to zoom, crop, flip, blur, etc. the input image 402. One augmented image 704 is input into a first, i.e., online, neural network 702, and the other augmented image 714 is input into a second, i.e., target, neural network 712. The first neural network 702 is defined by a first set of weights and includes an encoder 706, a projector 708, and a predictor 710. The second neural network 712 is defined by a second set of weights and includes an encoder 706 and a projector 708. The second set of weights are an exponential moving average of the first set of weights.

The augmented images 704, 714 are input to the respective encoders 706, 716. The encoders 706, 716 process the respective augmented images 704, 714 and output respective feature vectors for the corresponding augmented images 704, 714. The feature vectors correspond to a representation of object labels and locations included in the respective augmented images 704, 714. The feature vectors are then input to the respective projectors 708, 718. The projectors 708, 718 process the respective feature vectors and output respective projections for the corresponding representations. That is, the first neural network 702 outputs a first projection and the second neural network 712 outputs a second projection 720. A projection projects a feature vector to a reduced dimensional vector space. For example, the feature vector may be a 2048-dimensional vector, and the corresponding projection may be a 256-dimensional vector.

The first projection is then passed to the predictor 710. The predictor 710 processes the first projection and outputs a prediction 722 of the second projection. The predicted second projection 722 is compared to the second projection 720 to determine updated parameters of a loss function for the first neural network 702. That is, parameters of the loss function can be updated based on contrastive loss between the predicted second projection 722 and the second projection 720. Contrastive loss is computed as mean squared error between the predicted second projection 722 and the second projection 720, e.g., according to known computational techniques.

Back-propagation can compute a loss function based on the predicted second projection 722 and the second projection 720. A loss function is a mathematical function that maps values such as the predicted second projection 722 and the second projection 720 into real numbers that can be compared to determine a cost during training. In this example, the cost is the contrastive loss. The loss function determines how closely the predicted second projection 722 matches the second projection 720 and is used to adjust the first set of weights that control the first neural network 702. Weights or parameters include coefficients used by linear and/or non-linear equations included in the encoders 706, 716.

The weights of the loss function can be systematically varied and the output results can be compared to a desired result minimizing the respective loss function. As a result of varying the parameters or weights over a plurality of trials over a plurality of input images, a set of parameters or weights that achieve a result that minimizes the respective loss function can be determined. As another example, the weights of the loss function can be optimized by applying gradient descent to the loss function. Gradient descent calculates a gradient of the loss function with respect to the current parameters. The gradient indicates a direction and magnitude to move along the loss function to determine a new set of parameters. That is, a new set of weights can be determined based on the gradient and the loss function. Applying gradient descent reduces an amount of time for training by using the loss function to identify specific adjustments to the weights as opposed to selecting new parameters at random.

Once the BYOL 700 configuration is trained, the encoder 706 for the first neural network 702 can be removed and used to form latent variables 506 that correspond to the input images 402. That is, the CONV 502 includes the encoder 706 for the first neural network 702 of the trained BYOL configuration 700. The latent variables 506 formed by the encoder 706 can be provided to the FC 508 and processed to derive the plurality of features 404, 406, 408, 410, 412, as discussed above.

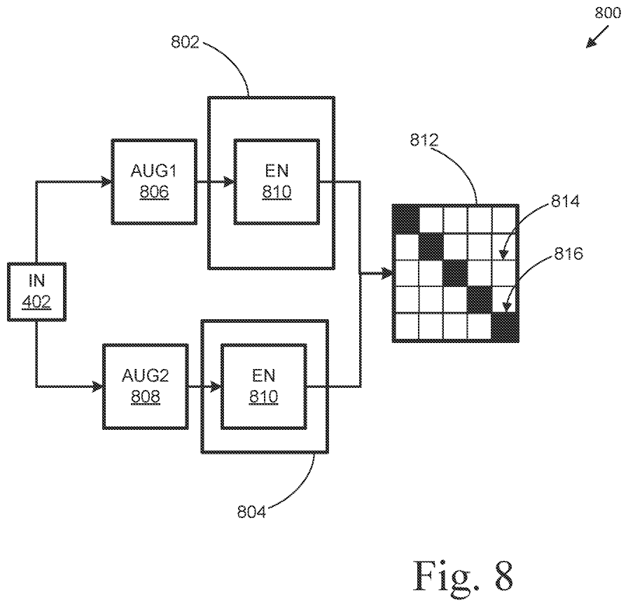

FIG. 8 is a diagram of an example BT configuration 800. A BT configuration 800, as is known, generates, from an input image 402, two augmented images 806, 808 that are different from each other, e.g., by employing image processing techniques to zoom, crop, flip, blur, etc. the input image 402. Different image processing techniques are used to generate the respective augmented images 806, 808, e.g., the input image 402 may be cropped to generate one augmented image 806, and the input image 402 may be flipped to generate the other augmented image 808. One augmented image 806 is input into a third neural network 802 defined by a set of weights and including an encoder 810, and the other augmented image 808 is input into a fourth neural network 804 defined by the set of weights and including the encoder 810. That is, the fourth neural network 804 is identical to the third neural network 802. The third and fourth neural networks 802, 804 process the respective augmented images 806, 808 and output respective feature vectors for the corresponding augmented image 806, 808.

A cross-correlation matrix 812 is computed based on the respective feature vectors output from the third and fourth neural networks 802, 804, e.g., according to known computational techniques. The cross-correlation matrix 812 contains elements 814 specifying respective correlations between pairs of elements of the feature vectors. The cross-correlation matrix 812 specifies absolute values between 0 and 1, inclusive. The value 1 indicates that the elements 814 of the respective vectors are the same. The value 0 indicates that the elements 814 of the respective vectors are orthogonal to each other. The cross-correlation matrix 812 is then compared to an identity matrix, i.e., a matrix specifying values of 1 for all elements on a main diagonal and values of 0 for all elements off the main diagonal, to determine a loss function for the third neural network 802 (and fourth neural network 804).

To minimize the loss function in the BT configuration 800, weights are adjusted to minimize a difference between the cross-correlation matrix 812 and the identity matrix, e.g., in substantially the same manner as discussed above regarding the BYOL configuration 700. Minimizing the difference between the cross-correlation matrix 812 and the identity matrix, e.g., adjusting weights such that elements 814 on a main diagonal 816 of the cross-correlation matrix 812 approach a value of 1 and elements 814 off the main diagonal 816 approach a value of 0, reduces redundancy between the respective feature vectors output by the third and fourth neural networks 802, 804.

Once the BT configuration 800 is trained, the encoder 810 can be removed and used to form latent variables 506 that correspond to the input images 402. That is, the CONV 502 includes the encoder 810 from the BT configuration 800. The latent variables 506 formed by the encoder 810 can be provided to the FC 508 and processed to derive the plurality of features 404, 406, 408, 410, 412, as discussed above.

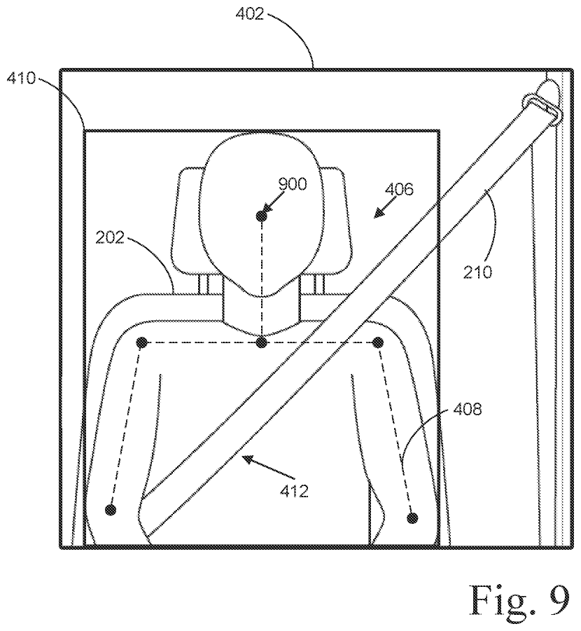

FIG. 9 is an example image 402 including a vehicle seat 202, a seatbelt webbing 304 in an extended state, and an occupant in the vehicle seat 202. After training the CONV 502, the DNN 500 can be trained according to multi-task learning techniques. Multi-task learning techniques share representations learned from one backbone, i.e., feature extractor, across multiple tasks. That is, the DNN 500 can be trained to accept an image 402 as input and to generate an output of the plurality of features 404, 406, 408, 410, 412 for the occupant with shared representations. Using multi-task learning improves the efficiency of training the DNN 500 as compared to individually training separate DNNs to output respective features 404, 406, 408, 410, 412.

To train the DNN 500, the remote server computer 140 selects one image 402 from the dataset and inputs the selected image 402 into the DNN 500 that outputs the plurality of features 404, 406, 408, 410, 412 for the occupant. Additionally, the remote server computer 140 determines the plurality of features 404, 406, 408, 410, 412 separate from the DNN 500, e.g., by employing image and data processing techniques (as discussed below). The remote computer 140 can then compare the output features 404, 406, 408, 410, 412 and the determined features 404, 406, 408, 410, 412 to determine a total offset that can be used to update parameters for a loss function for the DNN 500 (as discussed below). Using the plurality of features 404, 406, 408, 410, 412 to determine the updated parameters for the loss function allows the DNN 500 to train the plurality of nodes 602 in the output layer simultaneously, which reduces computational resources required to generate the plurality of features 404, 406, 408, 410, 412.

The remote server computer 140 can be programmed to classify and/or identify an occupant in a vehicle seat 202 based on the selected image 402, e.g., using known object classification and/or identification techniques. Various techniques such as are known may be used to interpret image data and/or to classify objects based on image data. For example, camera and/or lidar image data can be provided to a classifier that comprises programming to utilize one or more conventional image classification techniques. For example, the classifier can use a machine learning technique in which data known to represent various objects, is provided to a machine learning program for training the classifier. Once trained, the classifier can accept as input the selected image 402 from the dataset, and then provide as output, for each of one or more respective regions of interest (e.g., on the vehicle seat 202) in the image 402, an identification and/or a classification of an occupant or an indication that no occupant is present in the respective region of interest. In such an example, the classifier can output a binary value, e.g., 0 or 1, indicating a presence (1) or an absence (0) of an occupant in the vehicle seat 202.

Upon obtaining the output from the classifier, the remote server computer 140 can determine a first offset based on the output from the classifier and the output from the first node 602a of the output layer. The first offset is a binary value, e.g., 0 or 1, indicating a presence (1) or absence (0) of a difference between the respective identifications of an occupant in the vehicle seat 202 output by the classifier and the first node 602a of the output layer. For example, the remote server computer 140 can determine the first offset by subtracting the value output from the classifier from the value output from the first node 602a. As another example, the remote server computer 140 can determine the first offset has a value of 1 when the output from the classifier is different than the output from the first node 602a of the output layer, and the first offset has a value of 0 when the output from the classifier is the same as the output from the first node 602a of the output layer.

Upon determining the presence of the occupant in the vehicle seat 202, the remote server computer 140 can determine a physical state 406 for the occupant based on the image 402. For example, the classifier can be further trained with data known to represent various physical states 406 for occupants. Thus, in addition to identifying a presence of the occupant in the vehicle seat 202, the classifier can output an identification of a physical state 406 for the occupant. Once trained, the classifier can accept as input the image 402 and then provide as output the identification of the physical state 406 for the occupant.

Upon determining the physical state 406 for the occupant, the remote server computer 140 can determine a second offset based on the determined physical state 406 and the output from the second node 602b of the output layer. The second offset is a binary value, e.g., 0 or 1, indicating a presence (1) or absence (0) of a difference between the respective physical states 406 output by the classifier and the second node 602b of the output layer. For example, the remote server computer 140 can compare the determined physical state 406 to the physical state 406 output from the second node 602b. If the determined physical state 406 is the same as the physical state 406 output from the second node 602b, then the remote server computer 140 can determine that the second offset is 0. If the determined physical state 406 is different than the physical state 406 output from the second node 602b, then the remote server computer 140 can determine that the second offset is 1.

The remote server computer 140 determines a pose 408 for the occupant based on the selected image 402. For example, the remote server computer 140 can input the selected image 402 to a machine learning program that identifies keypoints 900. The machine learning program can be a conventional neural network trained for processing images, e.g., OpenPose, Google Research and Machine Intelligence (G-RMI), DL-61, etc. For example, OpenPose receives, as input, an image 402 and identifies keypoints 900 in the image 402 corresponding to human body parts, e.g., hands, feet, joints, etc. OpenPose inputs the image 402 to a plurality of convolutional layers that, based on training with a reference dataset such as Alpha-Pose, identify keypoints 900 in the image 402 and output the keypoints 900. The keypoints 900 include depth data that the image 402 alone does not include, and the remote server computer 140 can use a machine learning program such as OpenPose to determine the depth data to identify a pose 408 of the occupant in the image 402. That is, the machine learning program outputs the keypoints 900 as a set of three values: a length along a first axis of a 2D coordinate system in the image 402, a width along a second axis of the 2D coordinate system in the image 402, and a depth from the image sensor 115 to the vehicle occupant, the depth typically being a distance along a third axis normal to a plane defined by the first and second axes of the image 402. The remote server computer 140 can then connect the keypoints 900, e.g., using data processing techniques, to determine the pose 408 of the occupant.

Upon determining the pose 408 for the occupant, the remote server computer 140 can determine a third offset based on the determined pose 408 and the pose 408 output from the third node 602c of the output layer. The third offset is a difference between the coordinates of the keypoints 900 determined by the remote server computer 140 and the corresponding keypoints 900 output from the third node 602c. To determine the third offset, the remote server computer 140 can determine a difference between corresponding keypoints 900 of the respective poses 408. For example, the remote server computer 140 can determine a distance from each keypoint 900 of one pose 408 to the corresponding keypoint 900 of the other pose 408. In such an example, after determining the distances between each of the corresponding keypoints 900, the remote server computer 140 can, for example, use a mean square error (MSE) to determine an average difference between the keypoints 900 relative to the pixel coordinate system. In such an example, the third offset is determined from the average difference.

The remote server computer 140 can determine a bounding box 410 for the occupant using a two-dimensional (2D) object detector. That is, the remote server computer 140 can input the selected image to the 2D object detector that outputs a bounding box 410 for the occupant. The bounding box 410 is described by contextual information including a center and four corners, which are expressed in x and x and y coordinates in the pixel coordinate system. The 2D object detector, as is known, is a neural network trained to detect objects in an image 402 and generate a bounding box 410 for the detected objects. The 2D object detector can be trained using image data as ground truth. Image data can be labelled by user input. The human operators can also determine bounding boxes for the labeled objects. The ground truth including labeled bounding boxes can be compared to the output from the 2D object detector to train the 2D object detector to correctly label the image data.

Upon determining the bounding box 410 for the occupant, the remote server computer 140 can determine a fourth offset based on the determined bounding box 410 and the bounding box 410 output from the fourth node 602d of the output layer. The fourth offset is a difference between the coordinates of the bounding box 410 and the corresponding coordinates of the bounding box 410 output from the fourth node 602d. To determine the fourth offset, the remote server computer 140 can determine a difference between corresponding corners of the bounding box 410 output from the fourth node 602d and the bounding box 410 output from the 2D object detector. For example, the remote server computer 140 can determine a distance from each corner of the bounding box 410 output from the 2D object detector to the corresponding corner of the bounding box 410 output from the fourth node 602d. After determining the distances between each of the corresponding corners, the remote server computer 140 can use a mean square error (MSE) to determine an average difference between the corners of the respective bounding boxes 410 relative to the pixel coordinate system. In such an example, the fourth offset can be determined from the average difference.

The remote server computer 140 can determine a seatbelt webbing state 412 by performing semantic segmentation to the selected image 402. That is, the remote server computer 140 can identify edges or boundaries of the seatbelt webbing 304, e.g., by providing the selected image 402 as input to a machine learning program and obtaining as output a specified of a range of pixel coordinates associated with an edge of the seatbelt webbing 304. The remote server computer 140 can count a number of pixels contained within the specified range of pixel coordinates. The remote server computer 140 can then compare the number of pixels to a pixel threshold. If the number of pixels is greater than or equal to the pixel threshold, then the remote server computer 140 determines that the seatbelt webbing 304 is in an extended state. If the number of pixels is less than the pixel threshold, then the remote server computer 140 determines that the seatbelt webbing 304 is in a retracted state. The pixel threshold may be stored, e.g., in a memory of the remote server computer 140. The pixel threshold may be determined empirically, e.g., based on testing that allows for determining a minimum number of pixels that can be detected for various occupants having the seatbelt webbing 304 in an extended state.

Upon determining the seatbelt webbing state 412, the remote server computer 140 can determine a fifth offset based on the determined seatbelt webbing state 412 and the output from the fifth node 602e of the output layer. The fifth offset is a binary value, e.g., 0 or 1, indicating a presence (1) or absence (0) of a difference between the respective seatbelt webbing states 412 determined by the remote server computer 140 and output by the fifth node 602e of the output layer. For example, the remote server computer 140 can compare the determined seatbelt webbing state 412 to the seatbelt webbing state 412 output from the fifth node 602e. If the determined seatbelt webbing state 412 is the same as the seatbelt webbing state 412 output from the fifth node 602e, then the remote server computer 140 can determine that the fifth offset is 0. If the determined seatbelt webbing state 412 is different than the seatbelt webbing state 412 output from the fifth node 602e, then the remote server computer 140 can determine that the fifth offset is 1.

The remote server computer 140 can then determine a total offset by combing the first, second, third, fourth, and fifth offsets. That is, the total offset may be a function, e.g., an average, a weighted sum, a weighted product, etc., of the first, second, third, fourth, and fifth offsets.

The remote server computer 140 can update parameters of a loss function for the DNN 500 based on the total offset. Back-propagation can compute a loss function based on the respective features 404, 406, 408, 410, 412. A loss function is a mathematical function that maps values such as the respective output into real numbers that can be compared to determine a cost during training. In this example, the cost is the total offset. The loss function determines how closely the respective features 404, 406, 408, 410, 412 output from the DNN 500 match the corresponding features 404, 406, 408, 410, 412 determined by the remote server computer 140 and is used to adjust the parameters or weights that control the DNN 500. Parameters or weights include coefficients used by linear and/or non-linear equations included in the DNN 500. Upon determining the total offset, the remote server computer 140 can update the parameters of the loss function for the DNN 500, e.g., in substantially the same manner as discussed above regarding updating the loss function for the CONV 502.

The remote server computer 140 can then provide the updated parameters to the DNN 500. The remote server computer 140 can then determine an updated total offset based on the selected image 402 and the updated DNN 500. For example, the remote server computer 140 can input the selected image 402 to the updated DNN 500 that can output updated features 404, 406, 408, 410, 412. The remote server computer 140 can then determine updated first, second, third, fourth, and fifth offsets based on the updated features 404, 406, 408, 410, 412, e.g., in substantially the same manner as discussed above. The remote server computer 140 can then combine the updated first, second, third, fourth, and fifth offsets, e.g., in substantially the same manner as discussed above, to determine the updated total offset.

The remote server computer 140 can subsequently determine updated parameters, e.g., in substantially the same manner as discussed above with respect to updating the parameters of the loss function, until the updated total offset is less than a predetermined threshold. That is, parameters controlling the DNN 500 processing are varied until output features 404, 406, 408, 410, 412 match, within a predetermined threshold, the determined features 404, 406, 408, 410, 412 for each of the plurality of images 402 in the training dataset. The predetermined threshold may be determined based on, e.g., empirical testing to determine a maximum total offset that minimizes inaccurate occupant detection. Upon determining the total offset, the remote server computer 140 can compare the total offset to the predetermined threshold. The predetermined threshold may be stored, e.g., in a memory of the remote server computer 140. When the updated total offset is less than the predetermined threshold, the DNN 500 is trained to accept an image 402 including a vehicle seat 202 as input and to generate an output including the plurality of features 404, 406, 408, 410, 412 for the occupant.

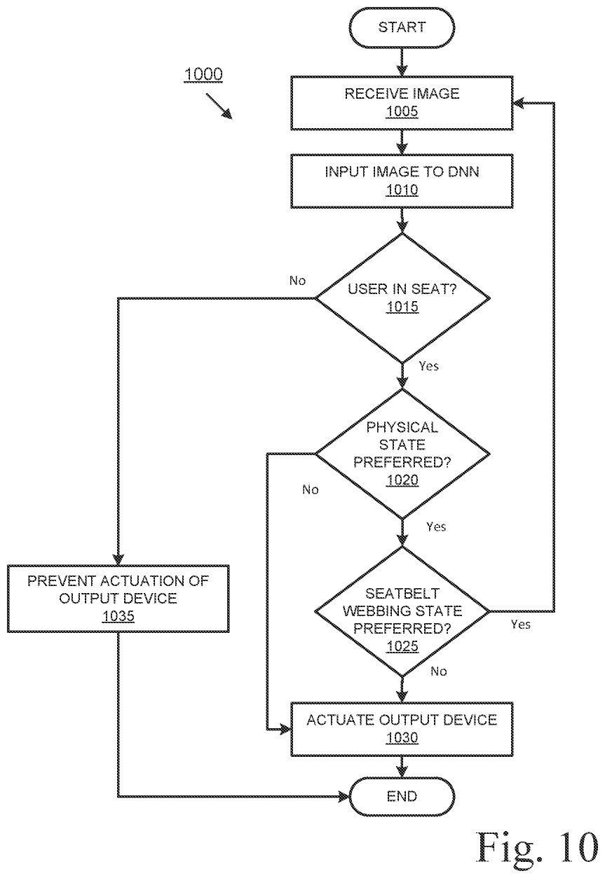

FIG. 10 is a diagram of an example process 1000 executed in a vehicle computer 110 according to program instructions stored in a memory thereof for actuating vehicle components 125 based on a plurality of features 404, 406, 408, 410, 412 for an occupant. Process 1000 includes multiple blocks that can be executed in the illustrated order. Process 1000 could alternatively or additionally include fewer blocks or can include the blocks executed in different orders.

Process 1000 begins in a block 1005. In the block 1005, the vehicle computer 110 receives data from one or more sensors 115, e.g., via a vehicle network. For example, the vehicle computer 110 can receive an image 402, e.g., from one or more image sensors 115. The image 402 may include data about the passenger cabin 208 of the vehicle 105, e.g., a vehicle seat 202, a seatbelt webbing 304, an occupant, etc. The process 1000 continues in a block 1010.

In the block 1010, the vehicle computer 110 inputs the image 402 to the DNN 500 that outputs a plurality of features 404, 406, 408, 410, 412 for the occupant, as discussed above. The process 1000 continues in a block 1015.

In the block 1015, the vehicle computer 110 determines whether an occupant is present in the vehicle seat 202 based on output from a first node 602a of the DNN 500, as discussed above. If the occupant is present in the vehicle seat 202, the process 1000 continues in a block 1020. Otherwise, the process 1000 continues in a block 1035.

In the block 1020, the vehicle computer 110 determines whether a physical state 406 for the occupant is classified as preferred. The vehicle computer 110 can determine the physical state 406 based on output from a second node 602b of the DNN 500, as discussed above. The vehicle computer 110 can classify the physical state 406 based on a look-up table, as discussed above. Additionally, the vehicle computer 110 can verify the classification for the physical state 406 based on a pose 408 of the occupant output from a third node 602c of the DNN 500, as discussed above. If the vehicle computer 110 verifies that the physical state 406 for the occupant is classified as preferred, the process 1000 continues in a block 1025. Otherwise, the process 1000 continues in a block 1030.

In the block 1025, the vehicle computer 110 determines whether a seatbelt webbing state 412 is classified as preferred. The vehicle computer 110 can determine the seatbelt webbing state 412 based on output from a fifth node 602e of the DNN 500, as discussed above. The vehicle computer 110 can then classify the seatbelt webbing state 412 by comparing a detected seatbelt webbing 304 to a bounding box 410 for the occupant output from a fourth node 602d of the DNN 500, as discussed above. Additionally, the vehicle computer 110 can verify the classification for the seatbelt webbing state 412 by determining a classification for an updated seatbelt webbing state 412 and comparing the classifications for the respective seatbelt webbing states 412, as discussed above. If the vehicle computer 110 verifies that the seatbelt webbing state 412 is classified as preferred, the process 1000 returns to the block 1005. Otherwise, the process 1000 continues in a block 1030.

In the block 1030, the vehicle computer 110 actuates an output device in the vehicle 105. As set forth above, the vehicle computer 110 can actuate a lighting component 125 and/or an audio component 125 to output a signal indicating the physical state 406 for the occupant and/or the seatbelt webbing state 412 is nonpreferred. Additionally, the vehicle computer 110 can actuate other vehicle components 125, e.g., a braking component 125 to slow the vehicle 105, a lighting component 125 to illuminate an area at which the occupant is looking, etc., and/or prevent actuation of some vehicle components 125, e.g., a propulsion component 125, as discussed above. The process 1000 ends following the block 1030. Alternatively, the process 1000 may return to the block 1005.

In the block 1035, the vehicle computer 110 prevents actuation of the output device in the vehicle 105. That is, the vehicle computer 110 may prevent actuation of the lighting component 125 and/or the audio component 125 to not output the signal. Additionally, the vehicle computer 110 may actuate one or more vehicle components 125, e.g., to operate the vehicle 105, as discussed above. The process 1000 ends following the block 1035. Alternatively, the process 1000 may return to the block 1005.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
obtain an image including a vehicle seat and a seatbelt webbing for the vehicle seat;
input the image to a neural network trained to, upon determining a presence of an occupant in the vehicle seat, output a physical state of the occupant and a seatbelt webbing state;
determine respective classifications for the physical state and the seatbelt webbing state, wherein the classifications are one of preferred or nonpreferred; and
actuate a vehicle component based on the classification for at least one of the physical state of the occupant or the seatbelt webbing state being nonpreferred.

2. The system of claim 1, wherein the neural network is further trained to, upon determining the presence of the occupant in the vehicle seat, output a bounding box for the occupant based on the image, and the instructions further include instructions to classify the seatbelt webbing state based on comparing the seatbelt webbing state to the bounding box.

3. The system of claim 2, wherein the instructions further include instructions to verify the classification for the seatbelt webbing state based on comparing an updated seatbelt webbing state to an updated bounding box.

4. The system of claim 1, wherein the neural network is further trained to, upon determining the presence of the occupant in the vehicle seat, output a pose of the occupant based on determining keypoints in the image that correspond to body parts of the occupant, and the instructions further include instructions to verify the physical state of the occupant based on the pose.

5. The system of claim 1, wherein the vehicle component is at least one of a lighting component or an audio component.

6. The system of claim 5, wherein the instructions further include instructions to prevent actuation of the vehicle component based on determining an absence of the occupant in the vehicle seat.

7. The system of claim 5, wherein the instructions further include instructions to prevent actuation of the vehicle component based on the classifications for the seatbelt webbing state and the physical state being preferred.

8. The system of claim 1, wherein the neural network includes a convolutional neural network having convolutional layers that output latent variables to fully connected layers.

9. The system of claim 8, wherein the convolutional neural network is trained in a self-supervised mode using two augmented images generated from one training image and a Bootstrap Your Own Latent configuration, and wherein the one training image is selected from a plurality of training images, each of the plurality of training images lacking annotations.

10. The system of claim 8, wherein the convolutional neural network is trained in a self-supervised mode using two augmented images generated from one training image and a Barlow Twins configuration, and wherein the one training image is selected from a plurality of training images, each of the plurality of training images lacking annotations.

11. The system of claim 8, wherein the convolutional neural network is trained in a semi-supervised mode using two augmented images generated from one training image and a Bootstrap Your Own Latent configuration, and wherein the one training image is selected from a plurality of training images, only a subset of the training images including annotations.

12. The system of claim 8, wherein the convolutional neural network is trained in a semi-supervised mode using two augmented images generated from one training image and a Barlow Twins configuration, and wherein the one training image is selected from a plurality of training images, only a subset of the training images including annotations.

13. The system of claim 1, wherein the neural network is trained to determine the seatbelt webbing state based on semantic segmentation.

14. The system of claim 1, wherein the neural network outputs a plurality of features for the occupant, including at least the determination of the presence of the occupant in the vehicle seat, the physical state of the occupant, and the seatbelt webbing state, and wherein the neural network is trained in a multi-task mode by determining a total offset based on offsets for the features and updating parameters of a loss function based on the total offset.

15. The system of claim 1, further comprising a remote computer including a second processor and a second memory storing instructions executable by the second processor to:
update the neural network based on aggregated data including data, received from a plurality of vehicles, indicating respective physical states and respective seatbelt webbing states; and
provide the updated neural network to the computer.

16. The system of claim 15, wherein the aggregated data further includes data, received from the plurality of vehicles, indicating bounding boxes for respective occupants and poses for respective occupants.

17. A method, comprising:
obtaining an image including a vehicle seat and a seatbelt webbing for the vehicle seat;
inputting the image to a neural network trained to, upon determining a presence of an occupant in the vehicle seat, output a physical state of the occupant and a seatbelt webbing state;
determining respective classifications for the physical state and the seatbelt webbing state, wherein the classifications are one of preferred or nonpreferred; and
actuating a vehicle component based on the classification for at least one of the physical state of the occupant or the seatbelt webbing state being nonpreferred.

18. The method of claim 17, wherein the vehicle component is at least one of a lighting component or an audio component.

19. The method of claim 18, further comprising preventing actuation of the vehicle component based on determining an absence of the occupant in the vehicle seat.

20. The method of claim 18, further comprising preventing actuation of the vehicle component based on the classifications for the seatbelt webbing state and the physical state being preferred.
